(19) United States
(12) Patent Application Publication
(10) Pub. No.: US 2019/0149813 A1
(43) Pub. Date: May 16, 2019

(54) METHOD AND APPARATUS FOR CAMERA FAULT DETECTION AND RECOVERY

(71) Applicant: Faraday&Future Inc., Gardena, CA (US)

(72) Inventor: Xinghui Sun, San Jose, CA (US)

(21) Appl. No.: 15/662,648

(22) Filed: Jul. 28, 2017

Related U.S. Application Data
(60) Provisional application No. 62/368,685, filed on Jul. 29, 2016.

(51) Int. Cl. H04N 17/00

(52) U.S. Cl. CPC H04N 17/002

(57) ABSTRACT

A system for camera fault detection, notification, and recovery is provided. The system may include at least one camera and at least one physical processing unit configured with program instructions. The processing unit may be configured to analyze image data received from the at least one camera and, based on the image analysis, detect a camera fault or malfunction.

### CROSS-REFERENCE TO RELATED APPLICATIONS

This application claims the benefit of U.S. Provisional Application No. 62/368,685, filed Jul. 29, 2016, the entirety of which is hereby incorporated by reference.

### TECHNICAL FIELD

The present disclosure relates generally to methods and systems for camera fault detection, notification, and recovery.

### BACKGROUND

Many modern vehicles rely on multiple cameras to provide various functions, including navigation, collision avoidance, and steering assistant. Electronic camera faults, such as power failure or failure to send any images, may be easy to detect electronically. Other types of camera faults, such as occluded or dirty lenses, may be difficult to detect electronically because the electronic function of the camera remains unaffected. Methods and systems presented herein may address certain camera faults.

### SUMMARY

In an embodiment, a system for camera fault detection is provided. The system may comprise a vehicle camera and one or more physical processors programmed by computer program instructions. When executed, the computer program instructions may cause the one or more physical processors to receive image data from the vehicle camera, analyze the image data received from the vehicle camera, determine a camera malfunction based on the analyzed image data, provide a camera malfunction notification signal based on the determined camera malfunction.

In another embodiment, a computer implemented method for vehicle camera fault detection and recovery is provided. The method may be implemented on a computer system having one or more physical processors programmed with computer program instructions to perform the method. The method may comprise receiving, via the computer system, image data from a vehicle camera, analyzing, via the computer system, the image data received from the vehicle camera, determining, via the computer system, a camera malfunction based on the analyzed image data, providing, via the computer system, a camera malfunction notification signal based on the determined camera malfunction.

In another embodiment, a system for camera fault detection is provided. The system may include a vehicle camera and one or more physical processors programmed by computer program instructions. When executed, the computer program instructions may cause the one or more physical processors to receive image data from the vehicle camera, compare the image data received from the vehicle camera with data received from another sensor, determine a camera malfunction if the image data is not consistent with the data received from the another sensor, and provide a camera malfunction notification signal based on the determined camera malfunction.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this disclosure, illustrate several embodiments and, together with the description, serve to explain the disclosed principles.

FIG. 1 is a graphical representation illustrating a vehicle.

FIG. 2 is a schematic of an exemplary control system layout of a vehicle.

FIG. 3 is a vehicle schematic illustrating exemplary camera locations.

FIG. 4 is a flow chart depicting steps of an exemplary camera fault detection and notification method according to an implementation of the present disclosure.

FIG. 5 is a flow chart depicting steps of an exemplary camera fault detection, notification, and recovery method according to an implementation of the present disclosure.

FIGS. 6A-D depict exemplary implementations of a camera cleaning device.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention.

Systems, methods, and apparatuses consistent with the present disclosure may be suitable for vehicle camera fault detection, notification, and recovery. Vehicle cameras may serve several functions, including navigation, collision avoidance, and steering assist. Camera faults or malfunctions may occur that reduce the effectiveness of the camera at carrying out designated functions, while not incapacitating the camera entirely. In such situations, the faulty camera may continue to send image data to vehicle computers. Embodiments consistent with the present disclosure provide means of detecting camera fault based on image data collected by the camera, notifying a user or vehicle system of the fault, and taking action to recover and/or compensate for the camera fault.

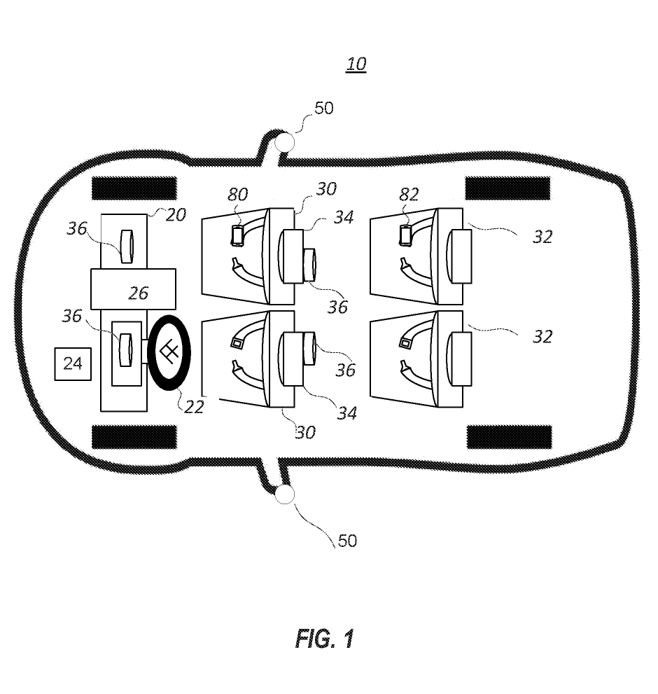

FIG. 1 is a graphical representation illustrating a vehicle 10 for camera fault detection, notification, and recovery, consistent with exemplary embodiments of the present disclosure. Vehicle 10 may have any body style of an automobile, such as a sports car, a coupe, a sedan, a pick-up truck, a station wagon, a sports utility vehicle (SUV), a minivan, or a conversion van. Vehicle 10 may also embody other types of transportation, such as motorcycles, boats, buses, trains, and planes. Vehicle 10 may be an electric vehicle, a fuel cell vehicle, a hybrid vehicle, or a conventional internal combustion engine vehicle. Vehicle 10 may be configured to be operated by a driver occupying vehicle 10, remotely controlled, and/or autonomous.

As illustrated in FIG. 1, vehicle 10 may include a number of components, some of which may be optional. Vehicle 10 may have a dashboard 20 through which a steering wheel 22 and a user interface 26 may project. In one example of an autonomous vehicle, vehicle 10 may not include steering wheel 22. Vehicle 10 may also have one or more front seats 30 and one or more back seats 32 configured to accommodate occupants. Vehicle 10 may further include one or more sensors 36 configured to detect and/or recognize occupants. The positions of the various components of vehicle 10 in FIG. 1 are merely illustrative. For example, sensor 36 may include an infrared sensor disposed on a door next to an occupant, and/or a weight sensor embedded in a seat. Vehicle 10 may also include detector and GPS unit 24 disposed at various locations, such as the front of the vehicle. The detector may include an onboard camera.

In some embodiments, user interface 26 may be configured to receive inputs from users or devices and transmit data. For example, user interface 26 may have a display including an LCD, an LED, a plasma display, or any other type of display, and provide a graphical user interface (GUI) presented on the display for user input and data display. User interface 26 may further include speakers or other voice playing devices. User interface 26 may further include input devices, such as a touchscreen, a keyboard, a mouse, and/or a tracker ball. User interface 26 may further include a housing having grooves containing the input devices. User interface 26 may be configured to provide internet access, cell phone access, and/or in-vehicle network access, such as Bluetooth™, CAN bus, or any other vehicle bus architecture protocol that may be used to access features or settings within vehicle 10. User interface 26 may be further configured to display or broadcast other media, such as maps and lane-specific route navigations.

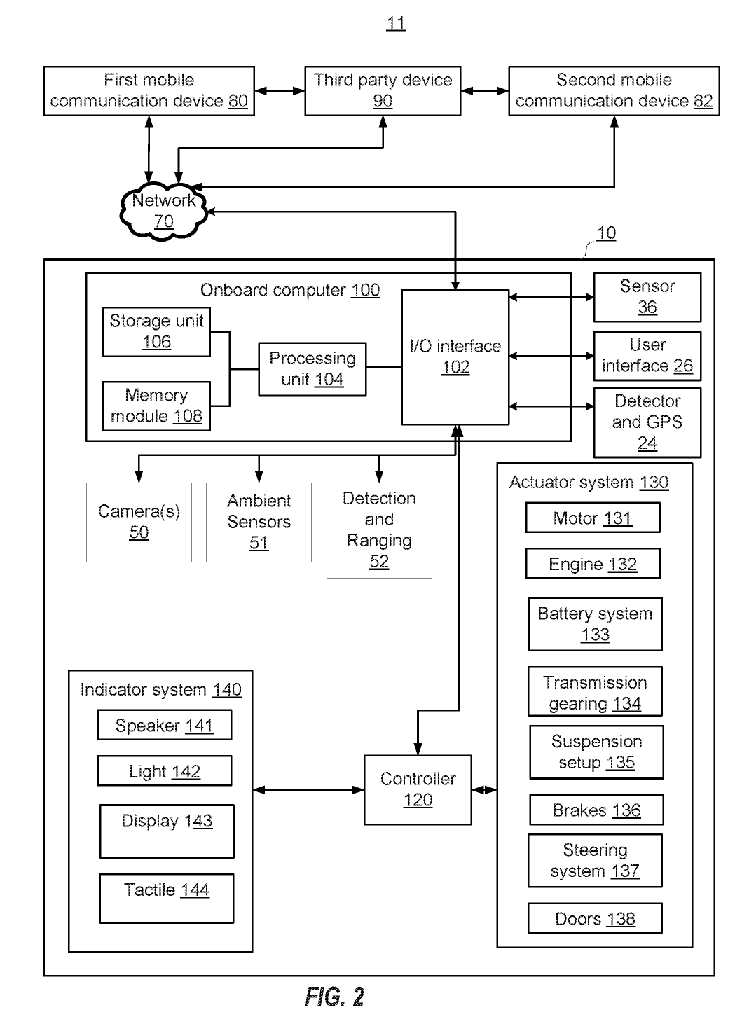

User interface 26 may also be configured to receive user-defined settings. For example, user interface 26 may be configured to receive occupant profiles including, for example, an age, a gender, a driving license status, an advanced driver assistance systems (ADAS) license status, an individual driving habit, a frequent destination, a store reward program membership, and etc. In some embodiments, user interface 26 may include a touch-sensitive surface configured to receive biometric data (e.g., detect a fingerprint of an occupant). The touch-sensitive surface may be configured to detect the ridges and furrows of a fingerprint based on a change in capacitance and generate a signal based on the detected fingerprint, which may be processed by an onboard computer described below with reference to FIG. 2. The onboard computer may be configured to compare the signal with stored data to determine whether the fingerprint matches recognized occupants. The onboard computer may also be able to connect to the Internet, obtain data from the Internet, and compare the signal with obtained data to identify the occupants. User interface 26 may be configured to include biometric data into a signal, such that the onboard computer may be configured to identify the person who is generating an input. Furthermore, user interface 26 may be configured to store data history accessed by the identified people.

Sensor 36 may include any device configured to generate a signal to be processed to detect and/or recognize occupants of vehicle 10, for example, camera, microphone sound detection sensor, infrared sensor, weight sensor, radar, ultrasonic, LIDAR, or wireless sensor for obtaining identification from occupants' cell phones. In one example, a camera 36 may be positioned on the back of a headrest 34 of a front seat 30 to capture images of an occupant in a back seat 32. In some embodiments, visually captured videos or images of the interior of vehicle 10 by camera 36 may be used in conjunction with an image recognition software, such that the software may distinguish a person from inanimate objects, and may recognize the person based on physical appearances or traits. The image recognition software may include a facial recognition software configured to match a captured occupant with stored profiles to identify the occupant. In some embodiments, more than one sensor may be used in conjunction to detect and/or recognize the occupant(s). For example, sensor 36 may include a camera and a microphone, and captured images and voices may both work as filters to identify the occupant(s) from the stored profiles.

In some embodiments, sensor 36 may include electrophysiological sensors for encephalography-based autonomous driving. For example, fixed sensor 36 may detect electrical activities of brains of the occupant(s) and convert the electrical activities to signals, such that the onboard computer can control the vehicle based on the signals. Sensor 36 may also be detachable and head-mountable, and may detect the electrical activities when worn by the occupant(s).

Detector and GPS 24 may determine in real time the location of vehicle 10 and/or information of the surrounding environment, such as street signs, lane patterns, road marks, road conditions, environment conditions, weather conditions, and traffic conditions, and send the information for processing as described below with reference to FIG. 2.

Vehicle 10 may be in communication with a plurality of mobile communication devices 80, 82. Mobile communication devices 80, 82 may include a number of different structures. For example, mobile communication devices 80, 82 may include a smart phone, a tablet, a personal computer, a wearable device, such as a smart watch or Google Glass™, and/or complimentary components. Mobile communication devices 80, 82 may be configured to connect to a network, such as a nationwide cellular network, a local wireless network (e.g., Bluetooth™ or WiFi), and/or a wired network. Mobile communication devices 80, 82 may also be configured to access apps and websites of third parties, such as iTunes™, Pandora™, Google™, Facebook™, and Yelp™.

In some embodiments, mobile communication devices 80, 82 may be carried by or associated with one or more occupants in vehicle 10. For example, vehicle 10 may be configured to determine the presence of specific people based on a digital signature or other identification information from mobile communication devices 80, 82. For instance, an onboard computer may be configured to relate the digital signature to stored profile data including the person's name and the person's relationship with vehicle 10. The digital signature of mobile communication devices 80, 82 may include a determinative emitted radio frequency (RF) or a global positioning system (GPS) tag. Mobile communication devices 80, 82 may be configured to automatically connect to or be detected by vehicle 10 through local network 70, e.g., Bluetooth™ or WiFi, when positioned within a proximity (e.g., within vehicle 10).

Vehicle 10 may be equipped with additional one or more cameras 50, located inside or outside the vehicle. Cameras 50 may capture image data, such as still images and/or video data, that may be useful for various vehicle functions, including, but not limited to, steering assist, navigation, cruise control assist, and parking assist.

FIG. 2 is a block diagram illustrating a system 11 for camera fault detection, notification, and recovery, consistent with exemplary embodiments of the present disclosure. System 11 may include a number of components, some of which may be optional. As illustrated in FIG. 2, system 11 may include vehicle 10, as well as other external devices connected to vehicle 10 through network 70. The external devices may include mobile terminal devices 80, 82, and third party device 90. Vehicle 10 may include a specialized onboard computer 100, a controller 120, an actuator system 130, an indicator system 140, a sensor 36, a user interface 26, a detector and GPS unit 24, one or more vehicle cameras 50, one or more ambient sensors 51, and one or more detection and ranging devices 52 (e.g., RADAR and/or LIDAR devices). Onboard computer 100, actuator system 130, and indicator system 140 may all connect to controller 120. Sensor 36, user interface 26, detector and GPS unit 24, vehicle cameras 50, ambient sensors 51, and detection and ranging devices 52 may all connect to onboard computer 100. The one or more cameras 50 may include front camera, back camera, side cameras. The ambient sensors 51 may include ambient light sensor, ambient sound sensor, etc. The detection and ranging device 52 may capture detection and ranging data, such as distances, speeds, and/or sizes of remote objects, that may be useful for various vehicle functions, including, but not limited to, steering assist, navigation, cruise control assist, and parking assist.

Onboard computer 100 may comprise, among other things, an I/O interface 102, a physical processing unit 104, a storage unit 106, a memory module 108. The above units of system 11 may be configured to transfer data and send or receive instructions between or among each other. Storage unit 106 and memory module 108 may be non-transitory and computer-readable and store instructions that, when executed by physical processing unit 104, cause vehicle 10 to perform the methods described in this disclosure. The onboard computer 100 may be specialized to perform the methods and steps described below.

I/O interface 102 may also be configured for two-way communication between onboard computer 100 and various components of system 11, such as user interface 26, detector and GPS 24, sensor 36, vehicle cameras 50, ambient sensors 51, and detection and ranging devices 52, as well as the external devices. I/O interface 102 may send and receive operating signals to and from mobile communication devices 80, 82 and third party devices 90. I/O interface 102 may send and receive the data between each of the devices via communication cables, wireless networks, or other communication mediums. For example, mobile communication devices 80, 82 and third party devices 90 may be configured to send and receive signals to I/O interface 102 via a network 70. Network 70 may be any type of wired or wireless network that may facilitate transmitting and receiving data. For example, network 70 may be a nationwide cellular network, a local wireless network (e.g., Bluetooth™ or WiFi), and/or a wired network.

Third party devices 90 may include smart phones, personal computers, laptops, pads, and/or servers of third parties (e.g., Google Maps™) that provide access to contents and/or stored data (e.g., maps, traffic, store locations, and weather). Third party devices 90 may be accessible to the users through mobile communication devices 80, 82 or directly accessible by onboard computer 100, via I/O interface 102, according to respective authorizations of the user. For example, users may allow onboard computer 100 to receive contents from third party devices by configuring settings of accounts with third party devices 90 or settings of mobile communication devices 80, 82.

Processing unit 104 may be configured to receive signals and process the signals to determine a plurality of conditions of the operation of vehicle 10, for example, through controller 120. Processing unit 104 may also be configured to generate and transmit command signals, via I/O interface 102, in order to actuate the devices in communication.

In some embodiments, processing unit 104 may be configured to receive and analyze image data from camera(s) 50. Image data received from camera 50 may include images and/or video. Images may be captured continuously, at frame rates ranging from multiple frames per second to multiple seconds between frames, depending on the circumstances. Image data may also include video, captured at any suitable frame rate.

Image data may be analyzed to detect, locate, and/or discover anomalies and/or inconsistencies in the image data. Detected anomalies in image data may include, for example, an inactive image area of the image data, a framerate decline in the image data, an image quality decline in the image data, and/or a misaligned camera.

Processing unit 104 may be configured to detect a camera fault based on the received image data. As described above, during image analysis, processing unit 104 may detect an anomaly within the image data. The detected anomaly may be graded by a severity of the anomaly. The severity of the anomaly may be based on a likelihood of the anomaly to cause vehicle systems to function poorly. For example, a minor scratch on a camera housing may be detectable by processing unit 104, but may represent only a minor distortion in image quality that does not affect vehicle performance or safety. In contrast, a splash of mud that entirely obscures the image of a camera 50 may severely affect vehicle performance and safety.

In some embodiments, processing unit 104 may also be configured to receive additional data, such as additional image data from an additional camera 50, detection and ranging data from a detection and ranging device 52, and/or ambient light data from an ambient light sensor 51. The additional data may be used by processing unit 104 in a comparison with image data collected by a specific camera 50 to assist in a fault determination of that specific camera 50.

In some embodiments, processing unit 104 may also be configured to provide a malfunction notification signal based on the determined camera malfunction. After a malfunction or fault has been determined, processing unit 104 may cause a notification signal to be provided. Such a signal may be provided to a user notification device—e.g., a vehicle HUD, main display, LED, dashboard, user smartphone, etc., and/or to vehicle controller 120. The notification signal may include information that a camera fault has occurred, which camera the fault has occurred in, and the severity of the fault.

In some embodiments, processing unit 104 may be configured to activate a camera fault recovery protocol. A camera fault recovery protocol may include, for example, the activation of camera cleaning devices and/or the provision of instructions to a user to fix or clean a camera unit. In some embodiments, a camera fault recovery protocol may include the use of supplemental data provided by another camera, a detection and ranging device, and/or other sources of information available to vehicle 10. Such other sources may include GPS data and/or vehicle to vehicle data. For example, where a forward looking camera has developed a fault during highway driving, the information it provides may no longer be suitable for an adaptive cruise control technique. However, if vehicle to vehicle information is available, processing unit 104 of a first vehicle may receive supplemental information from a second vehicle ahead of the first vehicle. Such supplemental information, which may include data about the second vehicles speed and braking, may assist processing unit 104 in implementing adaptive cruise control in the first vehicle.

Storage unit 106 and/or memory module 108 may be configured to store one or more computer programs that may be executed by onboard computer 100 to perform functions of system 11. For example, storage unit 106 and/or memory module 108 may be configured to process instructions to carry out the image analysis, and fault detection methods described herein. Storage unit 106 and/or memory module 108 may further be configured to store test image data and sample image data useful for carrying out image analysis and fault detection methods described herein.

Vehicle 10 can also include a controller 120 connected to the onboard computer 100 and capable of controlling one or more aspects of vehicle operation, such as performing autonomous parking or driving operations using instructions from the onboard computer 100, and/or operating camera cleaning units.

In some examples, the controller 120 is connected to one or more actuator systems 130 in the vehicle and one or more indicator systems 140 in the vehicle. The one or more actuator systems 130 can include, but are not limited to, a motor 131 or engine 132, battery system 133, transmission gearing 134, suspension setup 135, brakes 136, steering system 137, and door system 138. Steering system 137 may include steering wheel 22 described above with reference to FIG. 1. The onboard computer 100 can control, via controller 120, one or more of these actuator systems 130 during vehicle operation; for example, to open or close one or more of the doors of the vehicle using the door actuator system 138, to control the vehicle during autonomous driving or parking operations, using the motor 131 or engine 132, battery system 133, transmission gearing 134, suspension setup 135, brakes 136 and/or steering system 137, etc. The one or more indicator systems 140 can include, but are not limited to, one or more speakers 141 in the vehicle (e.g., as part of an entertainment system in the vehicle or part of user interface 26), one or more lights 142 in the vehicle, one or more displays 143 in the vehicle (e.g., as part of a control or entertainment system in the vehicle) and one or more tactile actuators 144 in the vehicle (e.g., as part of a steering wheel or seat in the vehicle). Onboard computer 100 can control, via controller 120, one or more of these indicator systems 140 to provide indications to a driver of the vehicle of one or more characteristics of the vehicle's surroundings. The characteristics may be determined by vehicle cameras 50, ambient sensors 51, and/or detection and ranging devices 52.

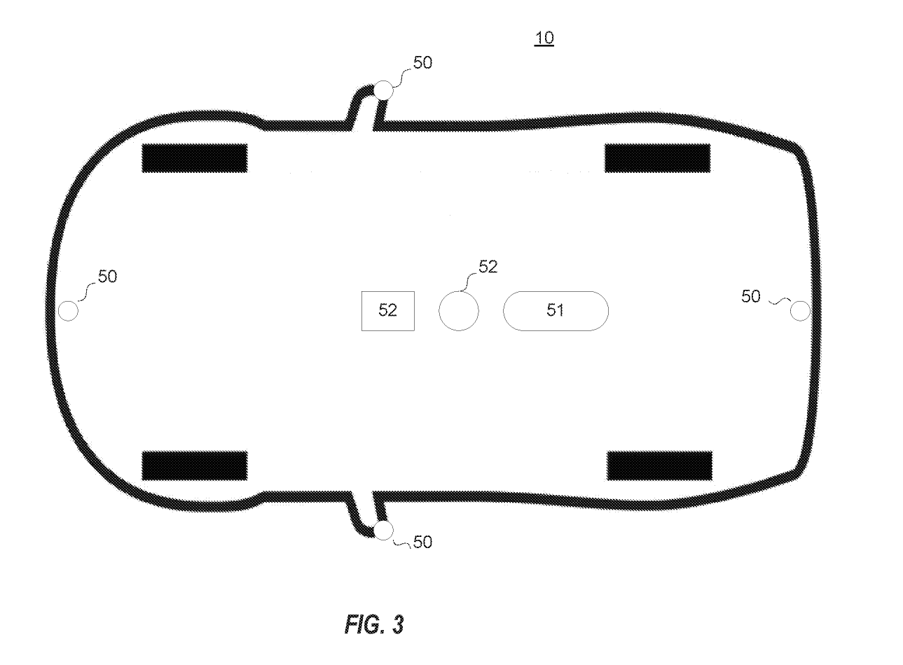

FIG. 3 illustrates an exemplary vehicle schematic with camera locations illustrated. As illustrated in FIG. 3, vehicle 10 may include one or more cameras. FIG. 3 illustrates cameras 50 located at front, rear, and side mirrors of vehicle 10. The illustrated camera locations are exemplary only. Methods and systems consistent with the disclosure may be operated in conjunction with any number of cameras located in any location on the exterior of vehicle 10 or in the interior of vehicle 10. In addition to cameras 50, vehicle 10 may further include at least one ambient sensor 51, and one or more detection and ranging devices 52, such as LIDAR and RADAR devices.

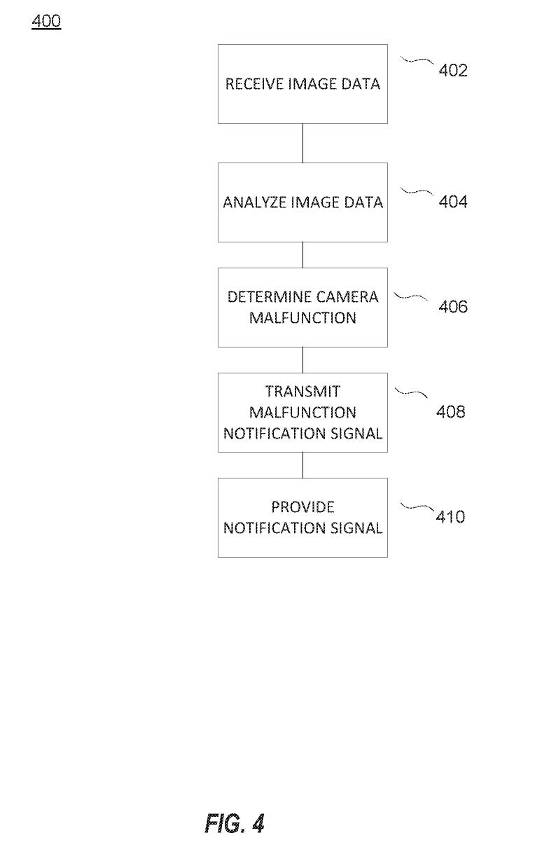

FIG. 4 is a flow chart depicting steps of an exemplary camera fault detection and notification method 400. A camera fault detection and notification method may be at least partially carried out by a processing unit 104 of onboard computer 100, which may interface with various aspects of vehicle 10 via I/O interface 102. As described with respect to FIG. 4, steps of a camera fault detection and notification method may be carried out by a processing unit 104 of onboard computer 100. In some implementations, some or all of the steps of camera fault detection and notification method 400 may be carried out by one or more processing units associated with and/or co-located with any of the vehicle cameras 50. In some implementations, some or all of the steps of camera fault detection and notification method 400 may be carried out by one or more processing units associated with and/or co-located with a respective vehicle camera 50 for which a fault is monitored/detected. In some implementations, some or all of the steps of camera fault detection and notification method 400 may be carried out by processing units associated with a cloud computing network.

In an operation 402, onboard computer 100 may receive image data from one or more vehicle cameras 50. As discussed above, such cameras 50 may be located anywhere on the exterior or interior of vehicle. Image data received from camera 50 may include images and/or video. Images may be captured continuously, at frame rates ranging from multiple frames per second to multiple seconds between frames, depending on the circumstances. Image data may also include video, captured at any suitable frame rate.

In an operation 404, onboard computer 100 may analyze the image data received from the one or more vehicle cameras 50. Image data may be analyzed to detect, locate, and/or discover anomalies and/or inconsistencies in the image data.

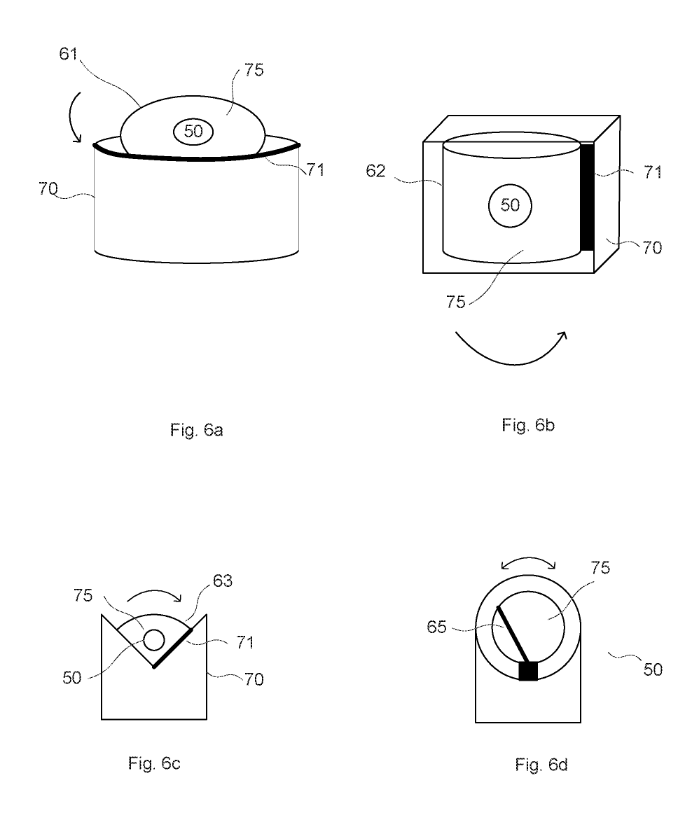

In some implementations, a detected anomaly may include an inactive image area of the image data. An inactive area of the image data may be a portion of the image data, such as a section of each frame of video or a consistent section of successive images, that shows minimal change or no change at all from one image or frame to the next. In the context of video data, an inactive area may be a portion of each successive video frame that experiences little to no change from one frame to the next. For example, where a portion of a camera viewing area 75 (illustrated, e.g., in FIGS. 6a-d) is occluded with dirt or debris, a video captured through the viewing area 75 may have an inactive area corresponding with the portion of the viewing area 75 covered in dirt. Inactive areas may also be caused, for example, due to malfunction of a portion of a camera optical sensor.

As used herein, viewing area 75 may refer to a surface through which a camera captures images. A viewing area 75 may include a camera lens and/or a transparent protective housing protecting a camera lens, through which a camera captures images.

In some implementations, a detected anomaly may include a framerate decline in the image data. A framerate decline may include a decline in the number of frames captured in a predetermined time period in video data, and/or a decline in the number of successive images captured in a predetermined time period. For example, for a camera that typically captures video at a framerate of 24 frames per second (FPS), video captured at 16 FPS would represent a framerate decline. Such a decline may be cause by damaged data cables and/or damage to a camera's internal systems.

In some implementations, a detected anomaly may include an image area having an image quality decline in the image data. An image quality decline may include a decline in contrast, a decline in focus, a decline in brightness, a decline in dynamic range, and/or any other decline in in image quality. Such a decline may occur over an portion of each image or frame of the image data. An image quality decline may be caused, for example, by dirt, scratches, and/or other imperfections in a camera viewing area 75 that do not cause total occlusion. Image quality decline may also be caused, for example, due to malfunction of a portion of a camera optical sensor.

In some implementations, a detected anomaly may include a misaligned camera. A camera may, over time and/or due to contact with a person, road debris, or other object, become misaligned. A camera may also become misaligned due to minor vehicle accidents and/or damage to a camera mounting system. A misaligned camera may fail to properly detect and image the areas that it is intended to image. In some implementations, onboard computer 100 may be programmed to detect a camera misalignment and designate such as an anomaly. Camera misalignment may be detected, for example, by comparison of image data with a baseline image that is taken in proper alignment.

In an operation 406, onboard computer 100 may determine a camera fault based on the analyzed image data. During image analysis, onboard computer 100 may detect an anomaly within the image data. A detected anomaly may be indicative of a camera fault, as described in the examples above. Based on the image data analysis, onboard computer 100 may determine that the detected anomaly constitutes a camera fault. Such a determination may be based on a predetermined threshold of quality or image loss. For example, if only a very small portion of the image area is inactive, or if only a small quality decline is detected, onboard computer 100 may determine that these detected anomalies do not yet constitute a camera fault. Image analysis techniques may be very sensitive and able to detect even small anomalies, thus making it impractical to notify a driver or try to perform a correction based on every detected anomaly. Thus, onboard computer 100 may determine that a camera fault exists or has occurred when a detected anomaly surpasses a specified predetermined threshold.

In some implementations, onboard computer 100 may determine a degree of camera fault. For example, a camera may have a fault significant enough to hamper optimal operation, e.g., a small inactive area that does not interfere with overall function, or a camera may have a more significant fault that may represent a vehicle safety threat, e.g., a large inactive area that prevents a camera from recognizing potential safety concerns. The degree of camera fault may fall anywhere between a slight fault and a complete malfunction.

In an operation 408, onboard computer 100 may provide a malfunction notification signal based on the determined camera malfunction. The provided signal may be a signal indicating that there is a malfunction in the camera system, a signal indicating that there is a malfunction in a particular camera, a signal indicating a particular type of malfunction in a particular camera, and/or any other suitable signal indicating fault with the vehicle cameras. The provided signal may be provided from onboard computer 100 via I/O interface 102 to various other vehicle systems, including, for example, a notification unit of user interface 126 and a controller 120. In implementations including detection of a degree of camera fault, the transmitted notification signal may include information regarding the degree of camera fault. In an operation 410, a notification signal may be provided. In some implementations, the notification signal may be provided to a vehicle user via user interface 26. In some implementations, the notification signal may be provided to controller 120, from which it may be routed to any of the various vehicle 10 subsystems. The notification signal may be provided to a vehicle user via user interface 26 in the form of a sound, such as a beep or siren, a light, or any other type of notification. The notification signal may be provided to a user via LEDs located within vehicle 10, via a HUD, via a user smartphone, via a main display of vehicle 10, and/or any other suitable means.

The notification signal may be provided so as to alert the user to a degree of severity of the camera fault. For example, where a camera fault prevents optimal operation, a vehicle user may be warned that a particular camera should be attended to. In another example, a vehicle user may be warned with a more urgent notification if a camera fault decreases vehicle safety. In some implementations, controller 120 may prevent vehicle operation if a degree of severity of a camera fault surpasses a predetermined threshold.

In some implementations, a system for camera fault detection and recovery may further include at least one additional sensor. Such a sensor may include, for example, at least one additional camera, at least one additional detection and ranging device (e.g., 52), and/or at least one additional ambient light sensor (e.g., sensor 51). In such implementations, onboard computer 100 may be configured to compare the image data received from the vehicle camera with data received from the additional sensor. Onboard computer 100 may further be configured to determine a camera malfunction if the image data is not consistent with the data received from the additional sensor. Inconsistencies between image data and sensor data is described in greater detail below, with respect to exemplary implementations of an additional sensor.

In some implementations, a system for camera fault detection and recovery may further include at least one additional camera 50. In such implementations, onboard computer 100 may further be configured to receive and analyze image data from the additional camera 50. A comparison between image data received from one camera 50 and additional image data received from an additional camera 50 may reveal that one of the cameras 50 has malfunctioned. Image data from overlapping fields of view of the two cameras 50 may be compared. If the compared image data does not match, it may indicate malfunction of one or both of the cameras 50. For example, a side mirror mounted camera 50 and a roof mounted omnidirectional camera 50 may have overlapping fields of view. If the portion of the roof mounted camera's field of view that overlaps with the field of view of the side mirror mounted camera 50, this disparity may indicate that one of the cameras has a fault. If the side mirror mounted camera captures images of a bright red firetruck and the roof mounted camera 50 does not capture similarly bright red images in an overlapping field of view, this disparity may indicate that one of the cameras 50 has a fault. In other implementations, image comparison between multiple cameras may include comparing images based on any of the above described analysis techniques (e.g., frame rate decline, inactive image area detection, image quality decline) used for detecting fault in a single camera.

In some implementations, a system for camera fault detection and recovery may further include at least one detection and ranging device 52. Detection and ranging devices 52 may include, for example, Radar and Lidar devices. In such implementations, onboard computer 100 may further be configured to receive and analyze detection and ranging data from the detection and ranging device 52. A comparison between image data received from one camera and detection and ranging data from the detection and ranging device 52 may reveal that camera 50 has malfunctioned. Data from overlapping fields of view of the camera 50 and the detection and ranging device 52 may be compared. If the compared data does not match, it may indicate malfunction of the camera 50. For example, a front mounted camera 50 and detection and ranging device 52 may each scan an area in front of the vehicle 10. If the detection and ranging device 52 detects the presence of an object at a certain distance, but the camera does not detect an object, this disparity may indicate a camera fault.

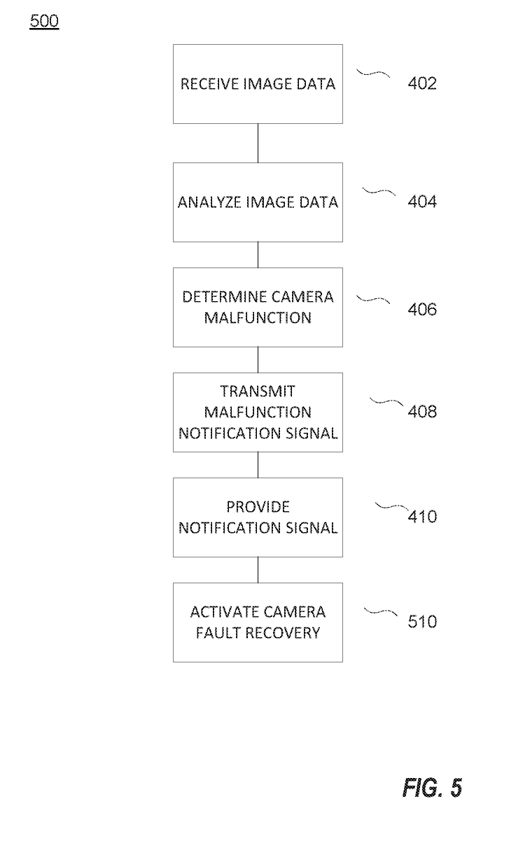

FIG. 5 is a flow chart depicting steps of an exemplary camera fault detection and recovery method 500. Operations 402-410 may be carried out as described above with respect to camera fault detection and notification method 400. In some implementations, some or all of the steps of camera fault detection and recovery method 500 may be carried out by processor 104 of onboard computer 100. In some implementations, some or all of the steps of camera fault detection and recovery method 500 may be carried out by one or more processing units associated with and/or co-located with any of the vehicle cameras 50. In some implementations, some or all of the steps of camera fault detection and recovery method 500 may be carried out by one or more processing units associated with and/or co-located with a respective vehicle camera 50 for which a fault is monitored/detected. In some implementations, some or all of the steps of camera fault detection and recovery method 500 may be carried out by processing units associated with a cloud computing network.

In an operation, after a fault notification signal has been provided to controller 120, controller 120 may activate a camera fault recovery operation 510. Camera fault recovery may include the activation of at least one camera cleaning device (described in greater detail below), the transmittal of instructions to a user to clean the faulted camera 50, and/or the activation of a supplemental data technique.

FIGS. 6a-d illustrate exemplary camera cleaning devices consistent with implementations of the present disclosure.

FIG. 6a illustrates a spherical camera cover 61. Spherical camera cover 61 may house and protect a camera 50, and may be configured to rotate within a housing 70 when activated. Rotation of the spherical camera cover may serve several purposes. As the cover 61 rotates within housing 70, a portion of cover 61 that has previously been inside of housing 70 may become the viewing area 75. The newly uncovered portion of cover 61 may be free of debris, dirt, and scratches and provide an unobstructed viewing area 75. Further, as a the dirty portion of cover 61 rotates into housing 70, a wiper 71, which may include a squee-gee or other type wiper and/or a brush, may be positioned so as to brush, wipe, or otherwise clean dirt and debris from cover 61 as it rotates past wiper 71.

FIG. 6b illustrates a cylindrical cover 62. Cylindrical cover 62 may house and protect a camera 50, and may be configured to rotate within a housing 70 when activated. Rotation of the cylindrical cover 62 may serve several purposes. As the cover 62 rotates within housing 70, a portion of cover 62 that has previously been inside of housing 70 may become the viewing area 75. The newly uncovered portion of cover 62 may be free of debris, dirt, and scratches and provide an unobstructed viewing area 75. Further, as a the dirty portion of cover 62 rotates into housing 70, a wiper 71, which may include a squee-gee or other type wiper and/or a brush, may be positioned so as to brush, wipe, or otherwise clean dirt and debris from cover 62 as it rotates past wiper 71.

FIG. 6c illustrates a disk cover 63. Disk cover 63 may cover and protect a camera 50, and may be configured to rotate within a housing 70 when activated. Rotation of the disk cover 63 may serve several purposes. As the cover 63 rotates within housing 70, a portion of cover 63 that has previously been inside of housing 70 may become the viewing area 75. The newly uncovered portion of cover 63 may be free of debris, dirt, and scratches and provide an unobstructed viewing area 75. Further, as a the dirty portion of cover 63 rotates into housing 70, a wiper 71, which may include a squee-gee or other type wiper and/or a brush, may be positioned so as to brush, wipe, or otherwise clean dirt and debris from cover 63 as it rotates past wiper 71.

FIG. 6d illustrates a camera viewing area 75 wiper device 65. Wiper device 65 may be configured to sweep back and forth across a camera viewing area 75 to clear any debris, dirt, and/or muck that has become attached to the viewing area 75.

In some implementations, camera fault recovery may include the transmittal of instructions to a user to correct the faulted camera 50. In addition to providing a camera malfunction notification signal to a user, computer 100 may provide to the user instructions that detail the location and type of camera fault, and instructions to correct the fault. Where a camera fault is caused due to viewing area 75 occlusion, a vehicle user may be instructed to clean the viewing area 75. Where a camera fault is caused due to a misaligned or unattached camera, a vehicle user may be instructed in how to properly reconnect the camera 50.

In some implementations, camera fault recovery may include the activation of a supplemental data technique. A supplemental data technique may include the use of additional image data from an additional camera. The additional image data may be received and analyzed and used by computer 100 to provide supplemental image data. The supplemental image data may be used by computer 100 to complement the image data that includes a detected anomaly from the faulted camera 50. The supplemental image data may include image data from the additional camera about the defective image portion in the image data. In some implementations, detection and ranging data from a detection and ranging device may be used by computer 100 as supplemental data. Such data may be used to in lieu of or in combination with image data from the faulted camera 50 to provide for safer operation of vehicle 10.

In some implementations, supplemental data may be provided by a vehicle to vehicle communication system. That is, a second vehicle 10 may provide image data to supplement the image data from the faulted camera 50 to provide safe operation of vehicle 10.

In some implementations, supplemental data may be provided by a detection and ranging device 52. Supplemental detection and ranging data may be used by onboard computer 100 to compensate for the lack of image data due to the detected camera fault. For example, where a forward looking camera has developed a fault and the system has determined that there is such a fault, onboard computer 100 may then determine to rely more on supplemental detection and ranging data in lieu of image data from the faulted camera.

Another aspect of the disclosure is directed to a non-transitory computer-readable storage medium storing instructions which, when executed, cause one or more processors to perform methods, as discussed above. The computer-readable storage medium may include volatile or non-volatile, magnetic, semiconductor, tape, optical, removable, non-removable, or other types of computer-readable storage medium or computer-readable storage devices. For example, the computer-readable storage medium may be the storage unit or the memory module having the computer instructions stored thereon, as disclosed. In some embodiments, the computer-readable storage medium may be a disc or a flash drive having the computer instructions stored thereon.

A person skilled in the art can further understand that, various exemplary logic blocks, modules, circuits, and algorithm steps described with reference to the disclosure herein may be implemented as specialized electronic hardware, computer software, or a combination of electronic hardware and computer software. For examples, the modules/units may be implemented by one or more processors to cause the one or more processors to become one or more special purpose processors to executing software instructions stored in the computer-readable storage medium to perform the specialized functions of the modules/units.

The flowcharts and block diagrams in the accompanying drawings show system architectures, functions, and operations of possible implementations of the system and method according to multiple embodiments of the present invention. In this regard, each block in the flowchart or block diagram may represent one module, one program segment, or a part of code, where the module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on the functions involved. Each block in the block diagram and/or flowchart, and a combination of blocks in the block diagram and/or flowchart, may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware for allowing specialized components to perform the functions described above. Furthermore, embodiments of the present disclosure may take the form of a computer program product embodied in one or more tangible and/or non-transitory computer-readable storage media containing computer-readable program codes. Common forms of non-transitory computer readable storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Embodiments of the present disclosure are described with reference to flow diagrams and/or block diagrams of methods, devices (systems), and computer program products according to embodiments of the present disclosure. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a computer, an embedded processor, or other programmable data processing devices to produce a special purpose machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer-readable memory that can direct a computer or other programmable data processing devices to function in a particular manner, such that the instructions stored in the computer-readable memory produce a manufactured product including an instruction means that implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions (which are executed on the computer or other programmable devices) provide steps for implementing the functions specified in one or more flows in the flow diagrams and/or one or more blocks in the block diagrams. In a typical configuration, a computer device includes one or more Central Processing Units (CPUs), an input/output interface, a network interface, and a memory. The memory may include forms of a volatile memory, a random access memory (RAM), and/or non-volatile memory and the like, such as a read-only memory (ROM) or a flash RAM in a computer-readable storage medium. The memory is an example of the computer-readable storage medium.

The computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The computer-readable medium includes non-volatile and volatile media, and removable and non-removable media, wherein information storage can be implemented with any method or technology. Information may be modules of computer-readable instructions, data structures and programs, or other data. Examples of a non-transitory computer-readable medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, a cache, a register, or any other non-transmission media that may be used to store information capable of being accessed by a computer device. The computer-readable storage medium is non-transitory, and does not include transitory media, such as modulated data signals and carrier waves.

The specification has described methods, apparatus, and systems for camera fault detection, notification, and recovery. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with the disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A system for camera fault detection, the system comprising:
a camera;
one or more physical processors programmed by computer program instructions that, when executed, cause the one or more physical processors to:
receive image data from the camera;
analyze the image data received from the vehicle camera;
determine a camera malfunction based on the analyzed image data; and
provide a camera malfunction notification signal based on the determined camera malfunction.

2. The system of claim 1, wherein to analyze the image data, the one or more physical processors are further caused to:
detect an inactive image area of the image data, and
wherein to detect the camera malfunction, the one or more physical processors are further caused to:
determine the camera malfunction based on the detected inactive image area.

3. The system of claim 1, wherein to analyze the image data, the one or more physical processors are further caused to:
detect framerate decline in the image data, and
wherein to detect the camera malfunction, the one or more physical processors are further caused to:
determine the camera malfunction based on the detected framerate decline.

4. The system of claim 1, wherein to analyze the image data, the one or more physical processors are further caused to:
detect an image area having an image quality decline in the image data, and
wherein to detect the camera malfunction, the one or more physical processors are further caused to:
determine the camera malfunction based on the detected image quality decline.

5. The system of claim 1,
further comprising an additional camera, and
wherein the one or more physical processors are further caused to:
receive additional image data from the additional camera data;
analyze the additional image data;
compare the image data and the additional image data; and
detect the camera malfunction based on the comparison between the image data and the additional image data.

6. The system of claim 1,
further comprising a detection and ranging device, and
wherein the one or more physical processors are further caused to:
receive detection and ranging data from the detection and ranging device;
analyze the detection and ranging data;
compare the image data and the detection and ranging data; and
detect the camera malfunction based on the comparison between the image data and the detection and ranging data.

7. The system of claim 1,
further comprising an ambient light sensor, and
wherein the one or more physical processors are further caused to:
receive ambient light data from the ambient light sensor;
analyze the ambient light data;
compare the image data and the ambient light data; and
detect the camera malfunction based on the comparison between the image data and the ambient light data.

8. The system of claim 1,
further comprising a camera cleaning device configured to clean a camera viewing area;
wherein the one or more physical processors are further caused to:
activate the camera cleaning device based on the detected camera malfunction.

9. The system of claim 1,
further comprising an additional camera;
wherein the one or more physical processors are further caused to:
receive additional image data from the additional camera, and
in response to a detected camera malfunction, process the additional image data to provide supplemental image data about a defective image area of the image data.

10. The system of claim 1,
further comprising an detection and ranging device;
wherein the one or more physical processors are further caused to:
receive detection and ranging data from the detection and ranging device, and
in response to a detected camera malfunction, process the detection and ranging data to provide supplemental data about a defective image area of the image data.

11. A computer implemented method for camera fault detection, the method being implemented on a computer system having one or more physical processors programmed with computer program instructions to perform the method, the method comprising:
receiving, via the computer system, image data from a camera;
analyzing, via the computer system, the image data received from the camera;
determining, via the computer system, a camera malfunction based on the analyzed image data;
providing, via the computer system, a camera malfunction notification signal based on the determined camera malfunction.

12. The method of claim 11, wherein analyzing the image data further comprises detecting an inactive image area of the image data, and
wherein detecting the camera malfunction further comprises determining the camera malfunction based on the detected inactive image area.

13. The method of claim 11, herein analyzing the image data further comprises detecting a framerate decline in the image data, and
wherein detecting the camera malfunction further comprises determining the camera malfunction based on the detected framerate decline.

14. The method of claim 11, wherein analyzing the image data further comprises detecting an image area having an image quality decline in the image data, and wherein detecting the camera malfunction further comprises determining the camera malfunction based on the detected image quality decline.

15. The method of claim 11, further comprising:
receiving, via the computer system, additional image data from the additional camera data;
analyzing, via the computer system, the additional image data;
comparing, via the computer system, the image data and the additional image data; and
detecting, via the computer system, the camera malfunction based on the comparison between the image data and the additional image data.

16. The method of claim 11,
receiving, via the computer system, detection and ranging data from a detection and ranging device;
analyzing, via the computer system, the detection and ranging data;
comparing, via the computer system, the image data and the detection and ranging data; and
detecting, via the computer system, based on the comparison between the image data and the detection and ranging data.

17. The method of claim 11,
receiving, via the computer system, ambient light data from an ambient light sensor;
analyzing, via the computer system, the ambient light data;
comparing, via the computer system, the image data and the ambient light data; and
detecting, via the computer system, the camera malfunction based on the comparison between the image data and the ambient light data.

18. The method of claim 11,
further comprising receiving, via the computer system, additional image data from an additional camera, and
in response to the detected camera malfunction, processing, via the computer system, the additional image data to provide supplemental image data about a defective image area of the image data.

19. The method of claim 11,
further comprising receiving, via the computer system, detection and ranging data from a detection and ranging device, and
in response to a detected camera malfunction, processing, via the computer system, the detection and ranging data to provide supplemental data about a defective image area of the image data.

20. A system for camera fault detection on a vehicle, the system comprising:
a vehicle camera;
one or more physical processors programmed by computer program instructions that, when executed, cause the one or more physical processors to:
receive image data from the vehicle camera;
compare the image data received from the vehicle camera with data received from another sensor on the vehicle;
determine a camera malfunction if the image data is not consistent with the data received from the another sensor; and
provide a camera malfunction notification signal based on the determined camera malfunction.
